(19) United States
(12) Patent Application Publication
(10) Pub. No.: US 2024/0129745 A1
(43) Pub. Date: Apr. 18, 2024

(54) VISION-BASED INTERFACE FOR CONTENT TRANSFER

(71) Applicant: Rovi Guides, Inc., San Jose, CA (US)

(72) Inventor: Serhad Doken, Bryn Mawr, PA (US)

(21) Appl. No.: 17/967,591

(22) Filed: Oct. 17, 2022

(51) Int. Cl. H04W 12/50; G06F 3/01; G06F 3/0484; G06F 9/451; G06V 10/74; H04L 9/40; H04L 67/141; H04L 67/51; H04W 12/06

(52) U.S. Cl. CPC H04W 12/50; G06F 3/013; G06F 3/0484; G06F 9/451; G06V 10/74; H04L 63/0428; H04L 67/141; H04L 67/51; H04W 12/06

(57) ABSTRACT

Systems and methods for broadcasting images identifying a destination device as it appears in an environment for content transfer are disclosed. Systems include a first device which selects a profile image of itself as it appears in its environment and embeds the profile image in its identification profile. The first device transmits the identification profile over a network during a discovery phase and the identification profile is received by a second device located in proximity to the first device. The identification profile is verified as corresponding to the first device by comparing the profile image to a real-time image of the first device. When the profile image substantially matches the real-time image of the first device, pairing between the first device and second device is initiated or content is sent over the network from the second device to the first device.

### FIELD OF INVENTION

Embodiments of the present disclosure relate to broadcasting images identifying a destination device as it appears in the environment for content transfer.

### BACKGROUND

As more people use smart devices, sharing content between devices becomes more popular and widespread. Accordingly, there are higher expectations for more intuitive, efficient, and secure ways to share content between devices. As such, there is a need for improved methods for transferring content between devices.

### BRIEF DESCRIPTION OF THE FIGURES

The various objects and advantages of the disclosure will be apparent upon consideration of the following detailed description, taken in conjunction with the accompanying drawings, in which like reference characters refer to like parts throughout, and in which:

FIG. 1 is an illustrative diagram of a system for a vision-based interface for content transfer or pairing, in accordance with some embodiments of the disclosure;

FIG. 2 is a diagram of an illustrative system for a vision-based interface for content transfer or pairing, in accordance with some embodiments of the disclosure;

FIG. 3 is a flowchart of an exemplary process for using a vision-based interface for content transfer or pairing, in accordance with some embodiments of the disclosure;

FIG. 4A is a flowchart of an exemplary process for using a vision-based interface for content transfer or pairing by a destination device, in accordance with some embodiments of the disclosure;

FIG. 4B is a flowchart of an exemplary process for using a vision-based interface for content transfer or pairing by a sending device, in accordance with some embodiments of the disclosure;

FIG. 5A is a flowchart of an exemplary process for using a vision-based interface for content transfer or pairing by a destination device without camera functionality, in accordance with some embodiments of the disclosure; and

FIG. 5B is a flowchart of an exemplary process for pushing a profile image by a sending device, in accordance with some embodiments of the disclosure.

### DETAILED DESCRIPTION

In accordance with some embodiments disclosed herein, some of the above-mentioned limitations are overcome by selecting, by a first device, a profile image, wherein the profile image comprises an image of the first device appearing within a physical environment; embedding, by the first device, the profile image in an identification profile of the first device; transmitting, by the first device, the identification profile during a discovery phase, wherein the discovery phase includes a time period during which presence of the identification profile can be detected by a second device located within a particular distance of the first device; receiving, by the second device during the discovery phase, the identification profile; verifying, by the second device, the first device as corresponding to the identification profile by comparing the profile image with a captured image of the first device and determining that the profile image substantially matches the captured image; and in response to verifying the first device, sending content or permission to pair, by the second device, to the first device.

According to some embodiments, at least one of the first device or the second device comprises an augmented reality (AR) device. According to some embodiments, the identification profile is transmitted by the first device in response to a scan, by the second device, for discoverable devices. A prompt may be generated by the second device, wherein the prompt comprises a user interface (UI) element including the profile image; detecting a user interaction with the UI element, and the content or the permission to pair to the first device may be sent by the second device further in response to detecting a user interaction with the UI element. Detecting the user interaction with the UI element may further comprise detecting, by the second device, a user gaze held on at least one of the profile image or the captured image for a length of time. According to some embodiments, generating the prompt with the UI element further comprises displaying on an AR interface, by the second device, the profile image and the captured image such that the profile image and the captured image are simultaneously visible by way of the AR interface.

According to some embodiments, the invention described herein further comprises capturing, by the first device, the profile image, wherein the first device is an AR device. The profile image can include an image of a user associated with the first device, the image of the user captured by an inward facing camera of the first device. The profile image can include an image of an object located within a distance of the first device, the image of the object captured by an outward facing camera of the first device.

According to some embodiments, the invention described herein further comprises capturing, by the second device, the profile image of the first device; pushing, by the second device, the profile image to the first device; and embedding, by the first device, the pushed profile image in the identification profile of the first device. The first device may authenticate the second device based on the pushed profile image and accept the profile image.

According to one embodiment, the invention described herein further comprises establishing a peer-to-peer connection between the first device and the second device; encrypting the content; sending the encrypted content from the second device to the first device over the peer-to-peer connection.

According to some embodiments, the identification profile is transmitted over one of a wireless local area network (e.g., a Wi-Fi network), a personal area network (e.g., Bluetooth), or any other suitable wireless connection or network.

In accordance with some embodiments disclosed herein, the invention comprises: receiving, at a second device, an identification profile that has been transmitted by a first device and that includes a profile image of the first device that has been selected by the first device; verifying the first device as corresponding to the identification profile by comparing the profile image with a captured image of the first device and determining, based on the comparing, that the profile image and the captured image both depict a same device; and in response to verifying the first device, sending content or permission to pair from the second device to the first device. In an embodiment, the second device is an AR device and the captured image is captured via the second device.

According to some embodiments, the captured image is one of a plurality of captured images, each corresponding to a different device, and the verifying further comprises comparing the profile image to each of the plurality of captured images and determining, based on the comparing, that the captured image more closely matches the profile image than the others of the plurality of captured images. In some embodiments, the profile image is one of a plurality of profile images included in the identification profile; and the verifying is further based on comparing each of the plurality of profile images to the captured image and determining that the plurality of profile images and the captured image depict the same device.

In accordance with some embodiments disclosed herein, the invention comprises: selecting, by a first device, a profile image, wherein the profile image comprises an image of the first device appearing within a physical environment; embedding, by the first device, the profile image in an identification profile of the first device; transmitting, by the first device, the identification profile during a discovery phase, wherein the discovery phase includes a time period during which presence of the identification profile is detectable by one or more other devices within a particular distance of the first device; receiving, by the first device, a responsive communication from a second device, the responsive communication including content from the second device or permission to pair with the second device.

According to some embodiments, the responsive communication includes the permission to pair, and the invention further comprises establishing, in response to receiving the permission, a pair between the first and second devices.

According to some embodiments, transmitting the identification profile comprises transmitting the identification profile via a personal area network.

According to some embodiments, the first device is an AR device and wherein transmitting the identification profile occurs in response to the second device being identified via the AR device. In some embodiments, transmitting the identification profile occurs in response to the first device detecting a scan, by the second device, for discoverable devices.

The systems and methods described herein remove the need to rely on structures used by non-proximate devices for content sharing and pairing, thereby reducing device recognition errors and security and privacy concerns. To accomplish some of the aforementioned embodiments, the first device (e.g., a destination device) can capture the profile image of itself with, for example, its own camera (e.g., an inward facing camera). The profile image is an identifying image of the first device as it appears in its environment. The profile image is embedded into the identification profile of the first device, and the identification profile is broadcast during a discovery phase, to be recognized by other devices (e.g., a sending device, such as the second device) when scanning the network for discoverable devices to which to transfer content or initiate pairing. Prior to sending the content or initiating pairing, the second device verifies the identification profile is associated with the correct destination device (e.g., first device). The profile image of the first device is matched with a captured image (e.g., a real-time image) of the first device.

The uniquely identifying ability of the profile image removes complexity and processing delays associated with discovering destination devices when the identification profile uses a generic name or generic avatar (e.g., a stock photo). The profile image removes confusion from discovery, particularly by being more discernable than an identification profile of computer-generated identification number, such as a numeric expression or other string of alphanumeric characters. Because such strings of characters can be obscure to users, users may otherwise find difficulty in identifying and recognizing the appropriate identification profile for the intended destination device, and discovery could time out.

Verification of the identification profile by way of the easily identifiable profile image can also reduce or prevent the risk of attacks from interacting with a spoofed destination device. For example, the profile image being uniquely and easily identifiable reduces the risk of the identification profile being mistaken for a different identification profile, thereby preventing sensitive or confidential content from being transferred and preventing inadvertent pairing with an unauthorized or malicious device. Further, identification profile verification by way of the profile image improves the pairing of devices, as it removes the need for exchanging codes, PIN, private keys and delays caused by waiting for such exchanges (for example, due to failure to recognize and authorize such complicated codes, PIN, private keys, etc. which lead to their expiration and result in repeated attempts to generate and exchange new codes, PIN, private keys, etc.).

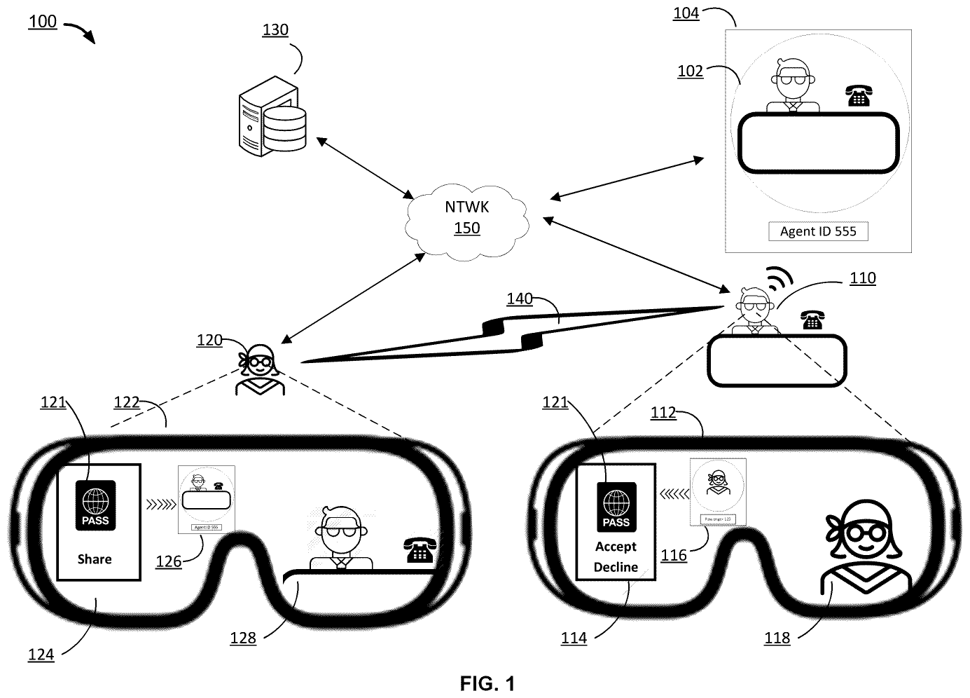

FIG. 1 is an illustrative diagram of a system 100 for a vision-based interface for content transfer or pairing, in accordance with some embodiments of the disclosure. In the example, a destination device 112 and a sending device 122 are within physical proximity of each other and pair with each other and/or engage in content transfer. In an embodiment, the devices 112, 122 may be any smart device, such as an augmented reality (AR) device (e.g., smart glasses, VR headset, etc.), smart phone, smart tablet, smart home assistant, smart TV, smart Bluetooth speaker, projector, in-vehicle infotainment system, connected lock, surveillance/security camera, any IoT device, etc. In an embodiment, smart devices 112, 122 may include a camera functionality, such as an outward facing camera and/or inward facing camera. In the example, the devices 112, 122 are pairs of smart glasses, worn by users 110, 120, respectively.

In an embodiment, the destination device 112 selects a profile image 102 associated with it and embeds the profile image 102 into its identification profile allowing the destination device 112 to be discoverable by sending device 122 for content transfer and/or pairing the devices 112, 122. An identification profile may be an attribute or a set of attributes which uniquely identifies the device, such as a Bluetooth Device Identification Profile (DIP), a Wi-Fi device structure, a Near Field Communication (NFC) tag or ID card, or any other set of device identifying properties (e.g., brand or manufacturer information, device name or device information, product identifier, etc.). In an embodiment, the profile image 102 is an identifying photo of the destination device 122 itself as it appears in the environment. The destination device 112 may capture its own profile image using its camera functionality. For example, an inward facing camera of the destination device 112 can capture an image of the user 110 wearing the destination device 112 as he appears in his environments. The profile image 102 is then embedded into the identification profile 104 of the destination device 112. In another example, the device 112 may have an outward facing camera, which captures an image of an object close by in the environment (e.g., the profile image can include a nearby landmark or building that is located within proximate physical presence of the destination device 112 and that can be viewed through a lens of destination device 112).

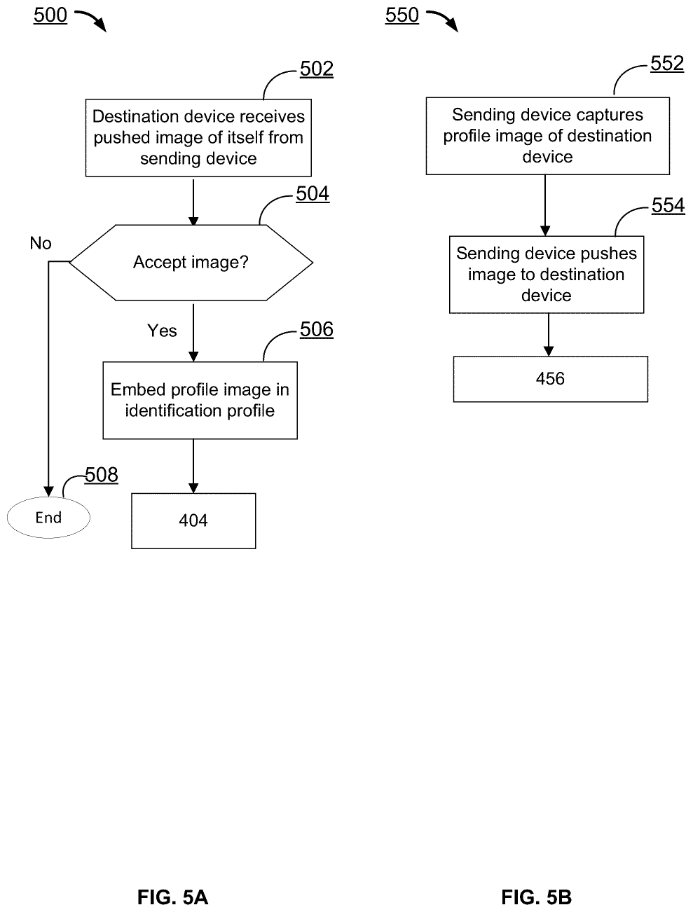

In another embodiment, when the destination device 112 does not have camera functionality, the destination device 112 can receive a pushed image of itself from another device. For example, the destination device 112 may be a Bluetooth speaker. The sending device 122 can capture an image of the destination device 112 as it appears in its environment and push the image to the destination device 112. Upon receiving the pushed image, destination device 112 can determine whether to accept or decline the image. If destination device 112 accepts the image, destination device 112 can use it as its profile image, embed it in its identification profile, and broadcast its identification profile to the network accordingly. Pushing the profile image from a sending device to a destination device is described in further detail in FIG. 5A and FIG. 5B.

Once the profile image 102 has been embedded in the identification profile 104, destination device 112 initiates a discovery phase (also referred to as discovery mode), during which destination device 112 broadcasts its identification profile over network 150. Network 150 can be a Bluetooth network, Wi-Fi network, personal area network, and the like. In another embodiment, the identification profile 104 may be broadcast via ultra-wideband (UWB) technology, via near-field communication (NFC) technology, among others. During the discovery phase, the destination device 112 can be discoverable to a sending device located in proximity (e.g., within a specific distance of) the destination device 112. The distance can depend on the range and/or strength of the network 150. For example, destination device 112 may only be discoverable to other devices within a smaller distance over a Bluetooth network or personal area network but can be discoverable within a larger distance over a strong Wi-Fi network. The scope of discoverability of destination device 112 can be modified. For example, when broadcasting its identification profile 104, destination device 112 can elect to have its identification profile 104 be discoverable (e.g., detectable) by the public or by a restricted list of devices, based on preconfigured settings, user preferences, etc. The discovery phase may be activated for a particular length of time and may automatically time out if no sending devices attempt to initiate a connection with the destination device 112 within the length of time.

In the example, sending device 122 is located nearby the destination device 112, scans network 150, and detects the broadcasted identification profile 104 of destination device 112. Once sending device 122 detects the destination device's identification profile 104, sending device 122 may initiate a connection 140 between the devices. The destination device 112 can transmit its identification profile 104 including its profile image 102 to sending device 122. In another embodiment, destination device 112 may activate discovery mode and broadcast its identification profile 104 in response to detecting that sending device 122 is actively scanning the network 150 for discoverable devices (for example, by way of the sending device 122 pinging the network 150 to discover a destination device). Upon entering discovery mode, destination device 112 can transmit its identification profile 104 including profile image 102 to sending device 122. In some instances, the destination device 112 transmits the identification profile at least partially in response to an identification of the sending device 122. For example, the sending device 122 may be an AR device, and a user may interact with an AR interface to gaze at or select, via the AR device, the sending device 122. In response, the destination device 112 may transmit the identification profile.

Once the sending device 122 receives the identification profile 104, sending device 122 may utilize the embedded profile image 102 to verify destination device 112 as the correct destination for transferring content and/or pairing. For example, sending device 122 activates external facing image sensors and scans for the environment to obtain a captured image (also referred to as a real-time image of a device and/or user associated with the device which substantially matches the profile image 102. Sending device 122 may detect user 110 (who is wearing destination device 112) in the environment, and image recognition techniques (e.g., CV algorithms) can be used to recognize the captured image 128 of user 110 as substantially matching the profile image 102. The captured image 128 is a real-time image (also referred to as actual physical image) or a near-real-time image of user 110 as captured by sending device 122. The recognition confirms that the destination device 112, as worn by user 110, is indeed associated with the identification profile 104 and is the correct recipient for content transfer and/or the correct device for pairing. Further in an embodiment, verification is complete when sending device 122 has focused its camera on the recognized captured image 128 of user 110 for a threshold amount of time. Alternatively, user 120 may be prompted to direct her gaze at user 110 (e.g., by way of viewing the captured image 128 of user 102 through sending device 122). Sending device 122 tracks user's 120 gaze and if the gaze is held on the captured image 128 of user 110 for at least a threshold amount of time, the identification profile 104 is verified. If no device corresponding to the profile image 102 is recognized within the threshold amount of time, the process will time-out.

Verification of the identification profile 104 of the destination device 112 can promote security and privacy with respect to content transfers and pairing. For example, user 110 may be a TSA agent, a bank teller, or other person who handles highly sensitive or confidential information. Without verification of the identification profile 104, user 120 could potentially send sensitive or confidential information to a device that is using a spoofed identification profile. It would benefit user 120 to verify that the destination device does indeed belong to the TSA agent when she transfers her passport and boarding pass to the device associated with the identification profile, or to the bank teller when she transfers her banking information to the device associated with the identification profile, and so forth.

Likewise, verification of the identification profile 104 of the destination device 112 can promote secure pairing with authorized devices. For example, in a situation where a user is casting a movie or printing confidential documents on a home device, the risks of inadvertently pairing the sending device with unauthorized devices (e.g., a neighbor's device) should be avoided. Likewise, a neighbor or uninvited guest who attempts to pair their unauthorized device with a user's home device would fail to verify the identification profile because the neighbor or guest is not within proximity (e.g., not inside the user's home) to the destination device and therefore not close enough to the destination device to hold their gaze on the captured image (e.g., gaze at the actual destination device). Verification of identification profile 104 can prevent pairing with malicious devices that are not authorized to be within proximity of the destination device 112. In another embodiment, verification of the identification profile 104 to initiate pairing removes the need for complicated exchanges between devices, such as waiting for exchange of PIN, keys, repeated attempts to pair after failed attempts from expiry PINs or keys, and so forth.

In an embodiment, sending device 122 may be prompted after verification of the destination device 112 to confirm initiation of content transfer or pairing. For example, sending device 122 may require user 120 to direct her gaze for a threshold period of time at user 110 (e.g., by way of viewing the captured image 128 of the user 110) as he is wearing destination device 112. In another example, sending device 122 may prompt user 120 to tap an icon (e.g., a share button 124, an icon 126 of the identification profile 104 or profile image 102 as viewed on the sending device 122, the captured image 128 of user 110 wearing destination device 112 as viewed on sending device 122, etc.) to confirm initiation of transfer or pairing.

Once initiation of transfer is confirmed, the content 121 can be transferred through connection 140 between the devices 112, 122. Connection 140 may be a Bluetooth connection, a connection over a personal area network, etc. In an embodiment, content 121 and/or connection 140 is encrypted. For example, connection 140 may be a peer-to-peer Wi-Fi connection and a firewall may be created around connection 140 prior to and during transfer.

After transfer, the destination device 112 can use an identification profile 116 and/or captured image 118 of user 120 for processing the transferred content. For example, a TSA agent may be prompted with an icon 114 to accept or decline the transferred content 121 (or in the case of pairing, to accept or decline a pairing request). The destination device 112 can also track the gaze of user 110, for example user 110 holds his gaze on user 120 (e.g., via the captured image 118 of user 120 as viewed through destination device 112) or on the user's 120 profile image (e.g., as embedded in her identification profile 116) for a threshold amount of time. After accepting the content 121, for example, user's 120 digital passport, the destination device 112 can inspect the passport and determine whether the passport photograph matches the captured image 118 of user 120 (e.g., via image recognition techniques).

In another embodiment, after verification of the destination device 112, multimedia player control access of destination device 112 may be granted to the sending device 122. For example, destination device 112 may be a Bluetooth speaker, projector, smart TV, etc. The sending device 122 may be given multimedia player control access of destination device 112 via a multimedia player UI element (e.g., based on configuration settings, etc.), wherein the sending device 122 can control media player operations on the destination device 112. When certain media content is playing on destination device 112, the multimedia player UI element on the sending device 122 allows the sending device 122 to control operations on destination device 112 such as play, pause, record, forward/rewind, increase or decrease volume, and the like. In another embodiment, verification of the destination device 112 may grant sending device 122 to cast multimedia content on a screen of the destination device 112 (e.g., where destination device 112 is a smart TV, projector, etc.).

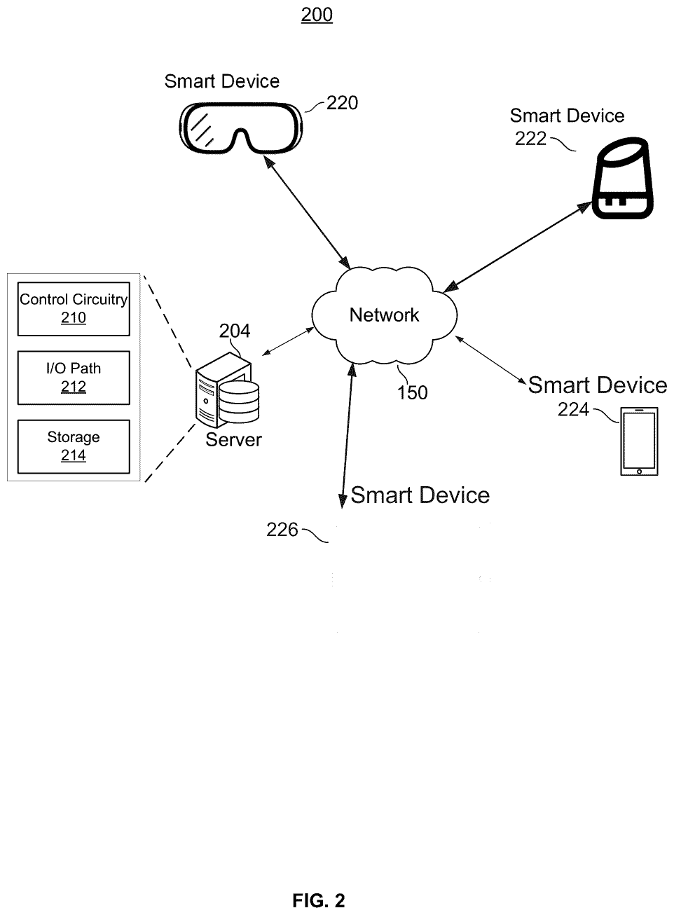

FIG. 2 is a diagram of an illustrative system 200 for a vision-based interface for content transfer or pairing, in accordance with some embodiments of the disclosure. Smart devices 220, 222, 224, and 226 may be coupled to communication network 150. In some embodiments, smart devices may be an AR device 220 (e.g., a pair of smart glasses), a smart speaker 222, smart phone 224, smart device 226, and the like. Communication network 150 may be one or more networks including the Internet, a mobile phone network, mobile voice, or data network (e.g., a 4G or LTE network), cable network, public switched telephone network, or other types of communications network or combinations of communications networks. Paths (e.g., depicted as arrows connecting the respective devices to communication network 150) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 2 to avoid overcomplicating the drawing.

Although communications paths are not drawn between smart devices, these devices may communicate directly with each other via communication paths as well as other short-range, point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The smart devices may also communicate with each other directly through an indirect path via communication network 150.

System 200 includes smart devices 220 (e.g., AR devices 112, 122 in FIG. 1), 222, 224, 226 and server 130. Communications with the smart devices 220, 222, 224, 226 and server 130 may be exchanged over one or more communications paths but are shown as a single path in FIG. 2 to avoid overcomplicating the drawing. In addition, there may be more than one of each of smart device 220, 222, 224, 226 and server 130, but only one of each is shown in FIG. 2 to avoid overcomplicating the drawing.

In some embodiments, the server 130 may include control circuitry 210 and storage 214 (e.g., RAM, ROM, Hard Disk, Removable Disk, etc.). The server 130 may also include an input/output path 212. I/O path 212 may provide device information, or other data, over a local area network (LAN) or wide area network (WAN), and/or other content and data to control circuitry 210, which includes processing circuitry, and storage 214. Control circuitry 210 may be used to send and receive commands, requests, and other suitable data using I/O path 212. I/O path 212 may connect control circuitry 204 (and specifically processing circuitry) to one or more communications paths.

Control circuitry 210 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 210 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 210 executes instructions for an emulation system application stored in memory (e.g., storage 214).

Memory may be an electronic storage device provided as storage 214 that is part of control circuitry 210. As referred to herein, the phrase “electronic storage device” or “storage device” should be understood to mean any device for storing electronic data, computer software, or firmware, such as random-access memory, read-only memory, hard drives, solid state devices, quantum storage devices, or any other suitable fixed or removable storage devices, and/or any combination of the same. Nonvolatile memory may also be used (e.g., to launch a boot-up routine and other instructions).

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 130), which may be located centrally or at distributed locations, that provide cloud-based services to various types of users and devices connected via a network such as the Internet via communication network 150. In such embodiments, user equipment devices may operate in a peer-to-peer manner without communicating with a central server.

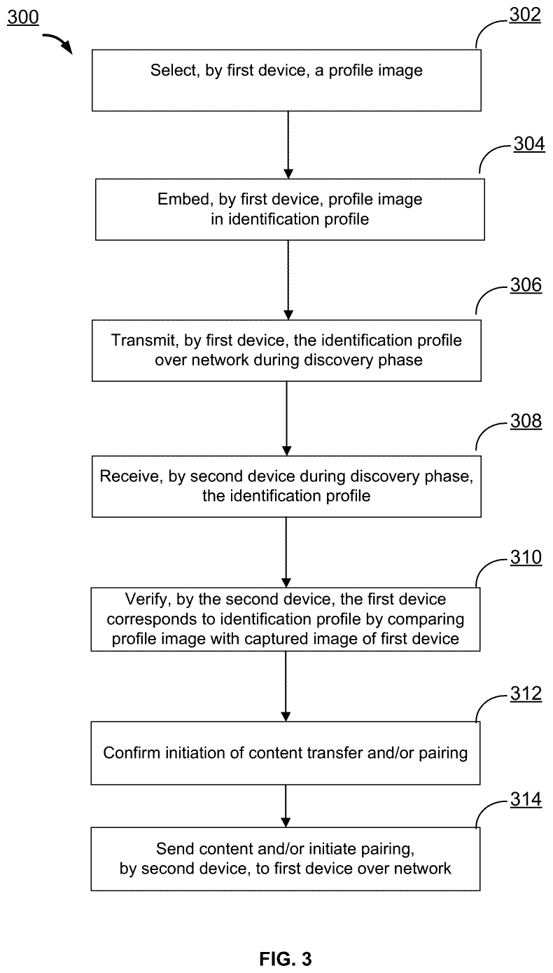

The systems and devices described in FIG. 2 enable not only the illustrative embodiment of FIG. 1, but also the execution of processes described in FIGS. 3-5. It should be noted that each step of processes described in FIGS. 3-5 is performed by the previously described control circuitry (e.g., in a manner instructed to control circuitry 204 or 210 by a content presentation system). It should be noted that the embodiments of FIGS. 3-5 can be combined with any other embodiment in this description and are not limited to the devices or control components used to illustrate the processes.

FIG. 3 is a flowchart of an exemplary process 300 for using a vision-based interface for content transfer or pairing, in accordance with some embodiments of the disclosure. In an embodiment, at step 302, the process selects, by a first device (e.g., a destination device), a profile image. The first device may be a smart device, such as an AR device, smart phone, smart tablet, smart TV, smart speaker, projector, in-vehicle infotainment system, connected lock, surveillance/security camera, any IoT device, etc. For example, the first device may be a pair of smart glasses. The profile image can be an identifying photo of the first device itself as it appears in the environment. The profile image may include an image of a user associated with the first device, wherein the user's image is captured via an inward facing camera the first device. In another example, the profile image may include an image of an object located within a distance of the first device, wherein the object's image is captured by an outward facing camera of the first device.

At step 304, the process embeds, by the first device, the profile image within the first device's identification profile. At step 306, the first device transmits the identification profile over a network during a discovery phase. The identification profile is received by a second device (e.g., sending device) at step 308. The network can be a Bluetooth network, Wi-Fi network, personal area network, and the like. During the discovery phase, the first device can be discoverable to the second device located in proximity (e.g., within a specific distance of) the first device. The distance can depend on the range and/or strength of the network. For example, the first device may be only discoverable to other devices within a smaller distance over a Bluetooth network or personal area network, but can be discoverable within a larger distance over a strong Wi-Fi network. Discoverability may be restricted to particular devices. For example, the identification profile may be broadcasted and discoverable to any device (e.g., the public), or the identification profile may be broadcasted and discoverable to only a select list of devices or types of devices (e.g., devices associated with family, friends, work contacts, etc.). The discovery phase may be activated for a particular length of time, and may automatically time out if no sending devices attempt to initiate a connection with the first device within the length of time. In another embodiment, the first device can transmit its identification profile to the second device (e.g., sending device), in response to detecting that the second device is scanning the network for discoverable devices for content transfer or pairing (e.g., by way of the second device pinging through the network for discoverable devices).

At step 310, the second device verifies whether the first device corresponds to the identification profile by comparing the profile image with a captured image of the first device. For example, the second device may extract the embedded profile image from the identification profile. The second device can activate external image sensors, scan for, and capture a real-time image of a device and/or user associated with the device which substantially matches the profile image. The second device may detect a user in the environment wearing the first device, and image recognition techniques (e.g., CV algorithms) can be used to recognize the user as matching the profile image, therefore confirming that the first device is associated with the identification profile. Further in an embodiment, verification is complete when the second device has focused its camera on the recognized captured image of the user for a threshold amount of time. For example, a user of the second device can be prompted to direct her gaze at the user of the first device (e.g., by way of viewing the real time image of the user through the second device). The second device tracks its user's gaze and if the gaze is held on the real-time image of user of the first device for at least a threshold amount of time, the identification profile is verified.

In another embodiment, verification of the identification profile may be determined by confirming multiple verification images. For example, multiple images may be shared by the first device (e.g., destination device) to the second device (e.g., sending device). The multiple images may be images of features in the environment shared by both devices. The second device must spot at least a minimum number of those images and recognize them. For example, the first device may send five images of objects from the shared environment (e.g., a desk, chair, clock, telephone, exit sign, etc.). The second device must spot (e.g., the user of the second device can hold their gaze on the captured image of those objects for at least five seconds) at least three of those objects, within a certain amount of time, and recognize them (e.g., match the object images with their real-time image counterparts). In another example, the first device may share multiple profile images (e.g., images of itself taken from different angles, in different environments, etc.), and the second device must recognize at least a minimum number of them (e.g., by verifying that they substantially match the captured image of the second device). Further in the example, the second device may need to recognize the minimum number of profile images within a specific time period. Such verification techniques can reduce the risk of attacks from interacting with a spoofed destination device. In some instances, the second device may verify the first device by comparing the received one or more profile images to multiple captured images (e.g., each corresponding to a different device in the vicinity). That is, the second device may not “know” which device in its vicinity is the first device. For example, a smart glasses device and a mobile phone might both be transmitting or broadcasting identification profiles with profile images. If content delivery or pairing is attempted between the second device and the smart glasses device, the second device may compare the received profile image with multiple captured images of known devices in the vicinity (e.g., including an image of the mobile phone) to identify the smart glasses device and to determine that the device transmitting the profile photo is, in fact, the smart glasses device it claims to be (e.g., by determining that the received profile image of the smart glasses corresponds to the known image of the smart glasses).

At step 312, confirmation may be requested of the second device (e.g., sending device) for initiation of the transfer or pairing. For example, the second device may require interaction with a confirmation icon. In another example, the second device can require its user to direct her gaze for a threshold period of time at the first device (e.g., destination device).

Once initiation of transfer or is confirmed, the content can be transferred from the second device to the first device at step 314. The content may be transferred over a secure or encrypted connection. The content itself may be encrypted prior to transfer. In another embodiment, a firewall may be created around the connection. Alternatively, once initiation of pairing is confirmed, a trusted, ongoing connection can be established between the devices.

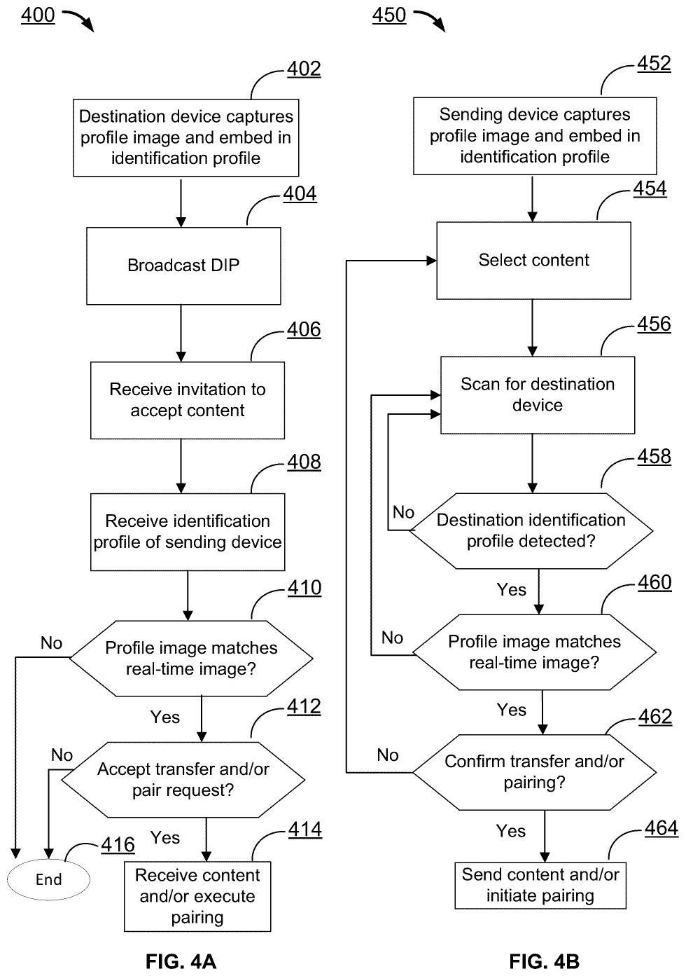

FIG. 4A is a flowchart of an exemplary process 400 for using a vision-based interface for content transfer by a destination device, in accordance with some embodiments of the disclosure. In an embodiment, at step 402, a destination device captures its profile image and embeds it into is identification profile. At step 404, the identification profile is broadcasted over a network. The identification profile may be detected by a sending device. In another embodiment, the destination device transmits its identification profile to the sending device in response to the sending device scanning the network for discoverable devices or for the destination device to which to transfer content.

At step 406, the destination device may receive an invitation to accept content from the sending device. In an embodiment, the invitation may be accompanied by the identification profile of the sending device at step 408. At step 410, the destination device verifies the identity of the sending device. For example, the identification profile of the sending device can be matched with a captured image (also referred to as a real-time image) of the sending device, which is in proximity to the destination device.

At step 412, the destination device determines whether to accept the invitation for content transfer or device pairing. The determination for accepting the invitation may be based on, for example, whether the identification profile of the sending device has been verified, whether the sending device is an authorized device with which the destination device can engage in content transfer or device pairing, and so forth. Once the invitation is accepted, the destination device receives the content at step 414. In another embodiment, pairing is initiated at step 414 to establish a trusted, ongoing connection between the devices.

FIG. 4B is a flowchart of an exemplary process 450 for using a vision-based interface for content transfer by a sending device, in accordance with some embodiments of the disclosure. In an embodiment, at step 452, the sending device captures its profile image and embeds it into its identification profile. This identification profile may be sent to the destination device during step 408. At step 454, the sending device selects content for transfer. In an embodiment, the content may be encrypted or password-protected prior to transfer.

At step 456, the sending device scans for a destination device to which to transfer the selected content. In an embodiment, the sending device may scan the network periodically until an identification profile of the destination device is discoverable. In another embodiment, the scanning by the sending device may trigger the destination device to transmit its identification profile to the sending device. At step 458, the process determines whether the identification profile of the destination has been detected. When the identification profile has been detected and received, the profile image of the destination device may be extracted from the identification profile. The profile image is compared to a captured image of the destination device at step 460.

In another embodiment, if more than one identification profile is recognized, the sending device can share content with all or some of the devices corresponding to those identification profiles. For instance, a first identification profile associated with a pair of smart glasses and a second identification profile associated with an audio device are both detected during the discovery phase. The sending device may connect with both of these devices, either sequentially or simultaneously, and transfer various content to both of them (for example, an image file to the smart glasses and an audio file to the audio device). Further in the example, the sending device can send the same content to multiple destination devices. For example, the sending device may share the same audio file (e.g., the same song) to both the smart glasses and the audio device, either sequentially or simultaneously.

At step 462, the sending device confirms whether to initiate the transfer. The content is then shared at step 464. In an embodiment, the content may be transferred regardless of whether the sending and destination device are paired or not. In an alternative embodiment, the sending device confirms whether to initiate pairing at step 462, and sends permission to pair to the destination device at step 464.

FIG. 5A is a flowchart of an exemplary process 500 for using a vision-based interface for content transfer or pairing by a destination device without camera functionality, in accordance with some embodiments of the disclosure. In an embodiment, the destination device lacks camera functionality and therefore cannot capture a profile image of itself as it appears in its environment. For example, the destination device may be a smart speaker or other audio device. In the embodiment, at step 502, the destination device receives a pushed profile image of itself from a sending device, wherein the sending device has camera functionality to capture the profile image of the destination device (e.g., step 552).

At step 504, the destination device determines whether to accept the pushed image of itself. In an embodiment, the determination may be based on whether both devices are registered under the same owner account, whether the sending device is included in a preconfigured list of authorized devices, and so forth. When the destination device accepts the pushed profile image, the profile image is embedded in the destination device's identification profile at step 506. The process continues to step 404 of FIG. 4A, where the destination device broadcasts its profile image embedded identification profile for discovery.

FIG. 5B is a flowchart of an exemplary process 550 for pushing a profile image by a sending device, in accordance with some embodiments of the disclosure. In an embodiment, the sending device is in proximity with the destination device, wherein the destination device has no camera capabilities to capture its own profile image. At step 552, the sending device uses its own camera functionality to capture the profile image of the destination device. The profile image is pushed to the destination device at step 554, wherein the destination device determines whether to accept or decline the pushed image. The process continues to step 456 of FIG. 4B, where the sending device scans the network for discoverable devices. If the destination device accepts the pushed image (e.g., at step 504), embeds the image into its identification profile and broadcasts the identification profile, the sending device may recognize the identification profile when scanning the network. In this embodiment, if the sending device was the one that initially captured and pushed the profile image of the destination device, the verification step (e.g., step 460) may be bypassed.

It will be apparent to those of ordinary skill in the art that methods involved in the above-mentioned embodiments may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
selecting, by a first device, a profile image, wherein the profile image comprises an image of the first device appearing within a physical environment;
embedding, by the first device, the profile image in an identification profile of the first device;
transmitting, by the first device, the identification profile during a discovery phase, wherein the discovery phase includes a time period during which presence of the identification profile can be detected by a second device located within a particular distance of the first device;
receiving, by the second device during the discovery phase, the identification profile;
verifying, by the second device, the first device as corresponding to the identification profile by comparing the profile image with a captured image of the first device and determining that the profile image substantially matches the captured image; and
in response to verifying the first device, sending content or permission to pair, by the second device, to the first device.

2. The method of claim 1, wherein at least one of the first device or the second device comprises an augmented reality (AR) device.

3. The method of claim 1, wherein the identification profile is transmitted by the first device in response to a scan, by the second device, for discoverable devices.

4. The method of claim 1, further comprising:
generating a prompt, by the second device, with a user interface (UI) element including the profile image;
detecting a user interaction with the UI element; and
sending, by the second device, the content or the permission to pair to the first device further in response to detecting a user interaction with the UI element.

5. The method of claim 4, wherein generating the prompt with the UI element further comprises:
displaying on an AR interface, by the second device, the profile image and the captured image such that the profile image and the captured image are simultaneously visible by way of the AR interface.

6. The method of claim 4, wherein detecting the user interaction with the UI element further comprises:
detecting, by the second device, a user gaze held on at least one of the profile image or the captured image for a length of time.

7. The method of claim 2, further comprising:
capturing, by the first device, the profile image, wherein the first device is an AR device.

8. The method of claim 1, wherein the profile image includes an image of a user associated with the first device, the image of the user captured by an inward facing camera of the first device.

9. The method of claim 1, wherein the profile image includes an image of an object located within a distance of the first device, the image of the object captured by an outward facing camera of the first device.

10. The method of claim 1, further comprising:
capturing, by the second device, the profile image of the first device;
pushing, by the second device, the profile image to the first device; and
embedding, by the first device, the pushed profile image in the identification profile of the first device.

11. The method of claim 10, further comprising:
authenticating, by the first device, the second device based on the pushed profile image; and
accepting, by the first device, the profile image.

12. The method of claim 1, further comprising:
establishing a peer-to-peer connection between the first device and the second device;
encrypting the content;
sending the encrypted content from the second device to the first device over the peer-to-peer connection.

13. The method of claim 1, wherein the identification profile is transmitted over a Wi-Fi network.

14. A system comprising:
control circuitry configured to:
select, by way of a first device, a profile image, wherein the profile image comprises an image of the first device appearing within a physical environment;
embed, by way of the first device, the profile image in an identification profile of the first device;
transmit, by way of the first device, the identification profile during a discovery phase, wherein the discovery phase includes a time period during which presence of the identification profile can be detected by a second device located within a particular distance of the first device;
receive, by way of the second device during the discovery phase, the identification profile;
verify, by way of the second device, the first device as corresponding to the identification profile by comparing the profile image with a captured image of the first device and determining that the profile image substantially matches the captured image; and
in response to verifying the first device, send content or permission to pair, by way of the second device, the first device.

15. The system of claim 14, wherein the control circuitry is further configured to:
generate a prompt, by way of the second device, with a user interface (UI) element including the profile image;
detect a user interaction with the UI element; and
send, by way of the second device, the content or the permission to pair to the first device further in response to detecting a user interaction with the UI element.

16. A method comprising:
receiving, at a second device, an identification profile that has been transmitted by a first device and that includes a profile image of the first device that has been selected by the first device;
verifying the first device as corresponding to the identification profile by comparing the profile image with a captured image of the first device and determining, based on the comparing, that the profile image and the captured image both depict a same device; and
in response to verifying the first device, sending content or permission to pair from the second device to the first device.

17. The method of claim 16, wherein the second device is an AR device and wherein the captured image is captured via the second device.

18. The method of claim 16, further comprising:
generating a prompt, by the second device, with a user interface (UI) element including the profile image;
detecting a user interaction with the UI element; and
sending, by the second device, the content or the permission to pair to the first device further in response to detecting a user interaction with the UI element.

19. The method of claim 16, further comprising performing the following prior to the selecting the profile image of the first device:
capturing, by the second device, the profile image of the first device;
pushing, by the second device, the profile image to the first device; and
embedding, by the second device, the pushed profile image in the identification profile of the first device.

20. The method of claim 16, wherein the captured image is one of a plurality of captured images, each corresponding to a different device; and
wherein the verifying further comprises comparing the profile image to each of the plurality of captured images and determining, based on the comparing, that the captured image more closely matches the profile image than the others of the plurality of captured images.

21. The method of claim 16, wherein the profile image is one of a plurality of profile images included in the identification profile; and
wherein the verifying is further based on comparing each of the plurality of profile images to the captured image and determining that plurality of profile images and the captured image depict the same device.

22. A method comprising:
selecting, by a first device, a profile image, wherein the profile image comprises an image of the first device appearing within a physical environment;
embedding, by the first device, the profile image in an identification profile of the first device;
transmitting, by the first device, the identification profile during a discovery phase, wherein the discovery phase includes a time period during which presence of the identification profile is detectable by one or more other devices within a particular distance of the first device;
receiving, by the first device, a responsive communication from a second device, the responsive communication including content from the second device or permission to pair with the second device.

23. The method of claim 22, wherein the responsive communication includes the permission to pair, and wherein the method further comprises establishing, in response to receiving the permission, a pair between the first and second devices.

24. The method of claim 22, wherein transmitting the identification profile comprises transmitting the identification profile via a personal area network.

25. The method of claim 22, wherein the first device is an AR device and wherein transmitting the identification profile occurs in response to the second device being identified via the AR device.

26. The method of claim 22, wherein transmitting the identification profile occurs in response to the first device detecting a scan, by the second device, for discoverable devices.
